(19) United States
(12) Patent Application Publication
(10) Pub. No.: US 2015/0019528 A1
(43) Pub. Date: Jan. 15, 2015

(54) PRIORITIZATION OF DATA FROM IN-MEMORY DATABASES

(71) Applicant: Santosh Vijayan, Bangalore (IN)

(72) Inventor: Santosh Vijayan, Bangalore (IN)

(73) Assignee: SAP AG, Walldorf (DE)

(21) Appl. No.: 13/941,098

(22) Filed: Jul. 12, 2013

(51) Int. Cl. G06F 17/30

(52) U.S. Cl. CPC G06F 17/30442
USPC 707/713

(57) ABSTRACT

Column accesses to columns of one or more database tables may be determined based on database queries accessing the one or more database tables. Row accesses to rows of the one or more database tables may be determined based on the queries. A priority may be assigned to a column of a row from the one or more database tables based on the determined column accesses of the column and the row accesses of the row. The column of the row may be moved from random access memory to hard disk based on the assigned priority.

### BACKGROUND

The data in database tables is conventionally stored in hard disks at a database server. A computer system may retrieve data from a database table and the fetched data may be stored in memory while the data is being utilized by the computer system. Traditionally, it has been prohibitively expensive to store entire database tables in memory. However, with major technological advances, entire database tables can now be stored in memory. An example of an in-memory database is SAP's High Performance Analytics Appliance (HANA™) database. Although in-memory databases store large amounts of data and offer fast data access, the performance of in-memory databases may be further optimized by prioritizing the data in the in-memory databases.

### BRIEF DESCRIPTION OF THE DRAWINGS

FIG. 1 illustrates a block diagram of a system to prioritize data in an in-memory database according to an embodiment.

FIG. 2 illustrates database tables with records tracked by an access tracker according to an embodiment.

FIG. 3 illustrates a block diagram of a system to prioritize data in an in-memory database according to an embodiment.

FIG. 4 illustrates an exemplary condition editor according to an embodiment.

FIG. 5 shows an exemplary architecture in an embodiment.

### DETAILED DESCRIPTION

Embodiments may be discussed in systems to prioritize data in in-memory databases. In an embodiment, column accesses to columns of one or more database tables may be determined based on database queries accessing the one or more database tables. Row accesses to rows of the one or more database tables may be determined based on the queries. A priority may be assigned to a column of a row from the one or more database tables based on the determined column accesses of the column and the row accesses of the row. The column of the row may be moved from random access memory to hard disk based on the assigned priority.

In an embodiment, the one or more database tables may be entirely stored in random access memory until moving of the column to the hard disk. In an embodiment, the priority is assigned based on a frequency of the determined column accesses of the column and the row accesses of the row.

In an embodiment, a text condition entered by a user via a graphical user interface may be received. The text condition may be converted into a database query. The database query may be executed to obtain results of the executed query. Database records may be identified in one or more database tables corresponding to the obtained results. A predetermined priority may be assigned to the identified database records. The database records may be moved from random access memory to hard disk based on the assigned priority.

In an embodiment, the predetermined priority may be received from the user via the graphical user interface along with the text condition. In an embodiment, a conflict between the text condition and another text condition may be resolved by comparing a timestamp of the text condition and a timestamp of the other text condition.

Conventionally, data is stored in one or more hard disks. When the data is required by a computer system, the data is loaded into memory (also known as random access memory (RAM)). Data in memory can be accessed much faster than data in a hard disk. However, memory is much more expensive (per storage unit) than hard disk. Therefore, to increase performance while minimizing costs, data that is currently utilized may be loaded by the computer system into memory and when the data is no longer utilized, the data in memory may be replaced with other currently used data.

The data in database tables are conventionally stored in hard disks at a database server. The data in a database table is organized as rows and columns of the table. Data required by a computer system may be retrieved as rows from the table and the fetched rows may be stored in memory while the data is being utilized by the computer system. Traditionally, it has been prohibitively expensive to store entire database tables in memory. However, with major technological advances, entire database tables can now be stored in memory. An example of an in-memory database is SAP's High Performance Analytics Appliance (HANA™) database.

Although in-memory databases store large amounts of data and offer fast data access, the data stored in-memory databases may further benefit from prioritization of the data. Specifically, data which is not utilized for extended periods of time may be moved into hard disk to increase the available space and the performance of the in-memory database.

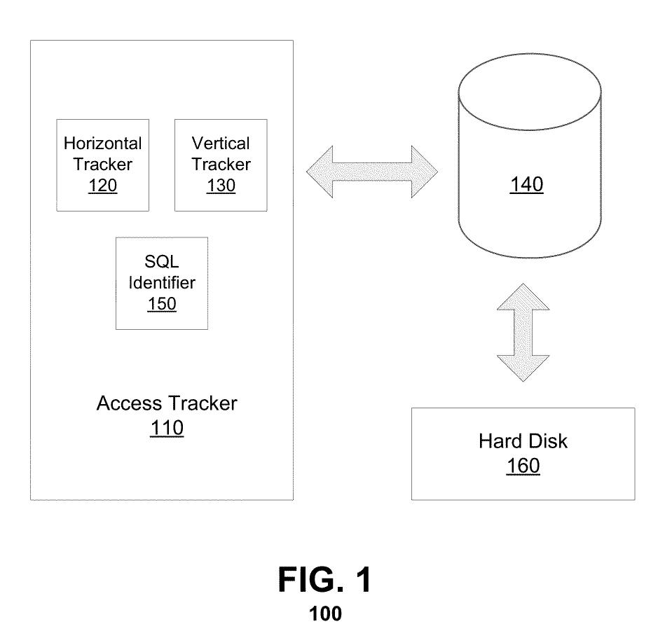

FIG. 1 illustrates a block diagram of a system to prioritize data in an in-memory database according to an embodiment. Database 140 is an in-memory database with one or more database tables. Access tracker 110 may track accesses (reads and/or writes) to the data in database 140. The access tracker 110 may include a structured query language (SQL) identifier 150 to identify the database operations which access the data in the database 140. The access tracker 110 may include a horizontal tracker 120 and a vertical tracker 130. The horizontal tracker may track accesses to the rows of the database tables in database 140. The vertical tracker 130 may track accesses to the columns of the database tables in database 140.

Based on the number and/or frequency of accesses of a database record, the record may be prioritized. For example, a database record may be assigned one of two priorities—a “hot” priority or a “cold” priority. The record may be classified as having a hot priority if, for example, the record has been accessed (as determined by the access tracker 110) at least once within the last six months. Otherwise, the record may be classified as having a cold priority. Depending on the priority level of the database record, one or more operations may be performed on the record. For example, if the database record is prioritized as cold, the record may be moved from the in-memory database 140 to hard disk 160. If the database record is prioritized as hot, the record may be retained in the in-memory database 140. In an alternate embodiment, the in-memory database 140 may include both memory storage and hard disk storage 160. If the database record is prioritized as cold, the record may be moved from the in-memory portion of the database 140 to hard disk portion 160 of the database. If the database record is prioritized as hot, the record may be retained in the in-memory portion of the database 140.

In an embodiment, one or more tables in an in-memory database 140 may be stored entirely in memory. In an embodiment, a substantial portion of a database table from the in-memory database 140 may be stored in memory and the rest of the database table may be stored in the hard disk 160 portion of the in-memory database 140. The portion of the database table stored in hard disk 160 may have been initially entirely stored in the memory portion of the database 140 and then moved to the hard disk 160 portion based on prioritization.

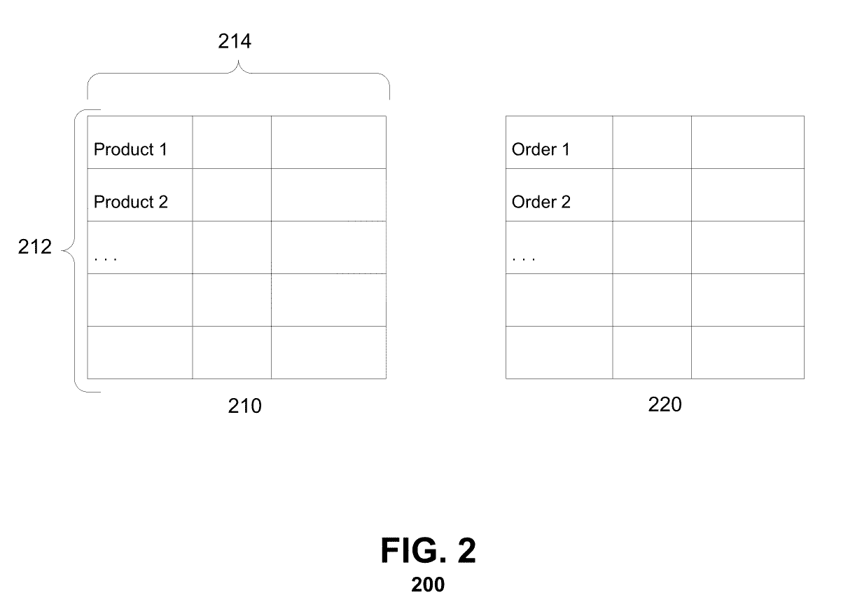

FIG. 2 illustrates database tables with records tracked by an access tracker according to an embodiment. In an embodiment, the in-memory database 140 may include a database table 210. Database table 210 may be, for example, a table with business product data. The product table 210 may include rows 212 of product data and each row may include information about a respective product. The information in each row may be organized as columns 214 with each column including a specific portion of information about the respective product. For example, the product table 210 may include three columns. The first column may indicate a product identifier to uniquely identify the product. The second column may indicate the price per unit of the product. The third column may indicate whether the status of the product (e.g., if the product is currently in stock).

Similarly, the in-memory database 140 may include another database table 220. Database table 220 may be, for example, a table with sales order data. The order table 220 may include rows and columns of order data as explained above. Each row may include information about a respective sales order. Each column including a specific portion of information about the respective sales order. For example, the sales order table 220 may include three columns. The first column may indicate a sales order identifier to identify the order. The second column may indicate the product identifiers of the products in that respective sales order. The third column may indicate the status of the respective sales order.

In an embodiment, a user and/or an application may perform an operation to retrieve the product identifiers of the products currently in stock. The operation may construct an SQL query to retrieve the requested information from the product table 210. The constructed query may be, for example, “SELECT product_id FROM product_table WHERE product_status=‘in stock’”. The SQL identifier 150 may identify the SQL query and determine that a SELECT statement is being executed on the product table 210. From the identified SQL query, the vertical tracker 130 may determine that the column, “product_id,” is being accessed because the “product_id” column is returned as part of the results. In a further embodiment, the vertical tracker 130 may determine that the column, “product_status” is being accessed because the “product_status” column is needed to execute SQL query to identify the rows of interest in the product table 210. The SQL query may then be executed and the rows corresponding to the query may be returned. In response, the horizontal tracker 120 may identify the returned rows as being accessed. The access tracker 110 (or a separate component, for example, a prioritizer) may then use the information determined by the horizontal tracker 120 and vertical tracker 120 to mark the “product_id” column and/or the “product_status” column a particular priority (e.g., “hot”). In an embodiment, this priority information may be stored in one or more separate database tables. In an embodiment, these database tables may be stored entirely in memory.

In an embodiment, based on the priority information, one or more operations may be performed on the product table 210. For example, a database optimizer may move all data from the product data table 210 which is not marked as “hot” to hard disk 160. That is, the database optimizer may only retain the rows and the columns within those rows prioritized as “hot” in the memory portion of database 140. All other rows and columns from the product table 210 may be moved by the database optimizer to hard disk 160.

In an embodiment, a user and/or an application may perform an operation to retrieve the sales orders which need to be fulfilled and whether the products in these sales orders are in stock. The operation may construct an SQL query to retrieve the requested information from the product table 210 and sales order table 220. The constructed query may be, for example, “SELECT order_id, product_status FROM order_table, product_table WHERE order_status=‘in progress’ AND order_table.product_id=product_table.product_id”. The SQL identifier 150 may identify the SQL query and determine that a SELECT statement is being executed on the product table 210 and the order table 220. As discussed above, from the identified SQL query, the vertical tracker 130 may determine that the columns, “order_id” and “product_status,” are being accessed because they are returned as part of the results. In a further embodiment, the vertical tracker 130 may determine that the columns, “order_status,” “order_table.product_id,” and “product_table.product_id,” are being accessed because these columns are needed to execute the SQL query to join the product table 210 and order table 220 and to identify the rows of interest. The SQL query may then be executed and the rows corresponding to the query may be returned. In response, the horizontal tracker 120 may identify the returned rows as being accessed. The access tracker 110 (or a prioritizer) may then use the information determined by the horizontal tracker 120 and vertical tracker 120 to mark the columns of the returned rows and/or the columns needed to fetch the rows a particular priority (e.g., “hot”). In an embodiment, this priority information may be maintained in one or more separate database tables.

In an embodiment, based on the priority information, one or more operations may be performed on the product table 210 and/or order table 220. For example, a database optimizer may move all data from the product table 210 and the order table 220 not marked as “hot” to hard disk 160. That is, the database optimizer may only retain the rows and the columns within those rows prioritized as “hot” in the memory portion of database 140. All other rows and columns from the product table 210 and order table 220 may be moved by the database optimizer to hard disk 160.

In an embodiment, the access tracker 110 may record timestamps of the accesses to the columns and rows. That is, the access tracker may maintain a log with a history of the times at which the rows and/or columns were accessed. In an embodiment the log may be stored as one or more tables in the in-memory portion of database 140. A prioritizer component (not shown) may then and assign a priority to the rows and/or columns based on the information in the log. In an embodiment, the prioritizer may mark any row/column combination accessed (or not accessed) a predetermined number of times over a predetermined period of time a particular priority. For example, the prioritizer may mark any row/column combination with more than 60 accesses over the last three months as “hot.” Similarly, the prioritizer may mark any row/column combination with 30 to 59 accesses over the last three months as “warm.” All other row/column combinations may be marked as “cold.” In an embodiment, the prioritizer may mark any row/column combination accessed (or not accessed) within a predefined period of time a particular priority. In an embodiment, the prioritizer may mark least recently accessed row/column combinations a particular priority. In an embodiment, the prioritizer may mark most recently accessed row/column combinations a particular priority.

In an embodiment, the log maintained by the access tracker 110 may include more granular information. For example, the access tracker 110 may include the type of operation which accessed the columns/rows. For example, the log may include whether the each access was a read, insert, modify, or delete operation. The prioritizer may then assign a priority to the rows and/or columns based on this additional information as discussed above. In an embodiment, a set of priority rules maintained in one or more database tables may define the priorities which should be assigned by the prioritizer. In an embodiment, the rules may be stored in the in-memory portion of database 140.

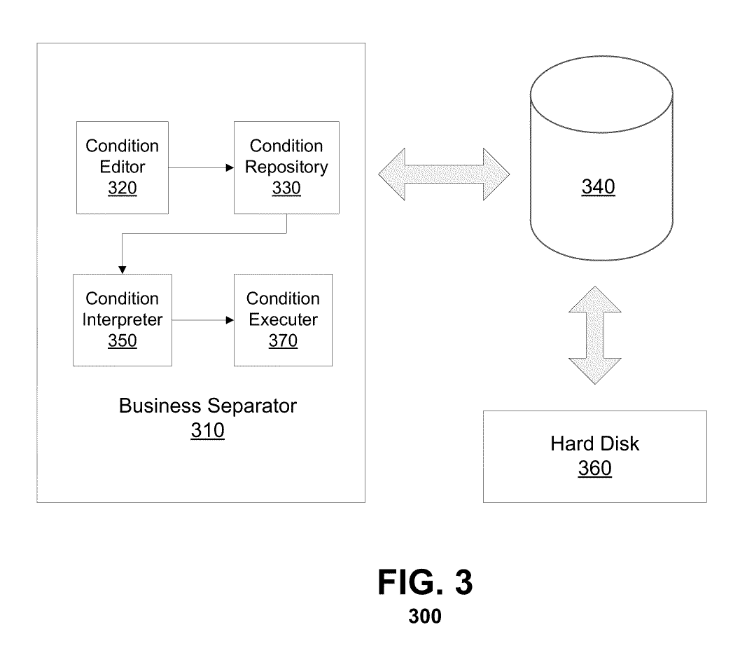

FIG. 3 illustrates a block diagram 300 of a system to prioritize data in an in-memory database according to an embodiment. Database 340 is an in-memory database (similar to database 140) with one or more database tables. Business separator 310 may perform processes to prioritize the data in database 340 based on user-defined business relevant conditions. The business separator 310 may include a condition editor 320, a condition repository 330, a condition interpreter 350, and a condition executer 370. The condition editor 320 may be utilized by users to specify business relevant conditions in simple text format to prioritize the data in database 340. The condition repository 330 may store the conditions defined by the users via the condition editor 320. The condition interpreter 350 may convert the conditions in the condition repository 330 into SQL statements. The condition executer 370 may execute the SQL statements generated by the condition interpreter 350. The output from the condition executer 370 may be utilized to prioritize the data in the database 340. Based on the respective priority, data may be moved to the hard disk 360 (similar to hard disk 160).

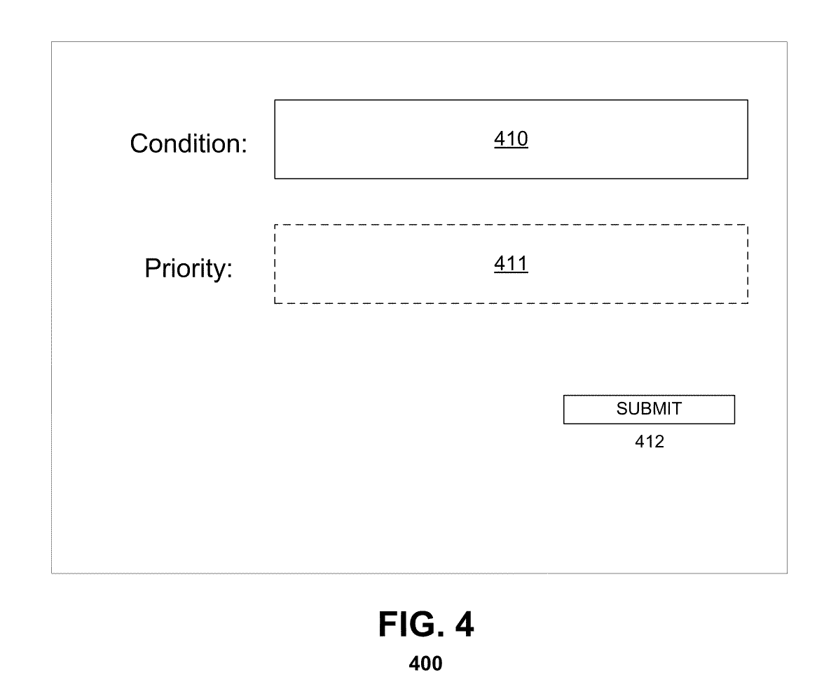

FIG. 4 illustrates an exemplary condition editor 400 according to an embodiment. Condition editor 400 may be an example of the condition editor 320 shown in block diagram 300. The condition editor 400 may include a field 410 to enter user-defined business conditions. A user may enter business relevant conditions in a text format in field 410. For example, the user may enter a business condition such as “order status is completed and all products from the order have been delivered” in field 410. In an embodiment, the user may optionally specify a priority in field 411 to be assigned to the data associated with the condition specified in field 410. In an embodiment, the field 411 may be populated with all available priorities and the user may select a priority from the pre-populated list (e.g., field 411 may be a pre-populated drop down menu). In response to the user activating a mechanism 412 displayed on condition editor 400 such as a “submit” button, the condition entered in field 410 may be saved in the condition repository 330. If the user entered a priority in field 411, the priority may also be stored in the condition repository 330 and associated with the respective condition. In an embodiment, the condition repository 330 may be a flat file. In an alternate embodiment, the condition repository 330 may be a database. In an embodiment, the condition repository may be one or more tables in the memory portion of database 340.

In an embodiment, in response to a request from a prioritizer component (not shown), the condition interpreter 350 may read one or more conditions from the condition repository 330 and convert the conditions to valid SQL statements. Returning to the example condition above, the condition, “order status is completed and all products from the order have been delivered,” may be converted by the condition interpreter 350 to “SELECT *.product_table FROM order_table, product_table WHERE order_status=‘completed’ AND product_status=‘delivered’ AND order_table.product_id=product_table.product_id.”

The condition executer 370 may then execute the SQL statement(s) output by the condition interpreter 350. The results from the executed SQL statement(s) may be obtained and the corresponding database records of the database tables indicated in the SQL statement(s) may be identified. The identified database records corresponding to the results returned from the execution of the SQL statement(s) may be assigned a predetermined priority. For example, as discussed above, a database record may be assigned one of two priorities—a “hot” priority or a “cold” priority. A returned record may be classified as having a cold priority. Depending on the priority level of the database record, one or more operations may be performed on the record. For example, if the database record is prioritized as cold, the record may be moved from the in-memory database 340 to hard disk 360. In an embodiment, the priority assigned to the returned database records may be the priority specified by the user via the condition editor 320 (e.g., field 411).

The database results obtained from executing the SQL statement(s) may be particular columns from particular rows of the tables identified in the SQL statement(s). Therefore, in certain embodiments, only the corresponding particular columns of the particular rows in the identified tables may be prioritized and/or moved to hard disk 360 (instead of, for example, the entire row).

In an embodiment, the condition interpreter 350 and/or the condition executer 370 may process multiple conditions from the condition repository 330. For example, the condition interpreter 350 and/or the condition executer 370 may process multiple conditions from the condition repository 330 as part of a batch process. In an embodiment, the condition interpreter 350 may process one or more conditions from the condition repository 330 and store the respective SQL statements in an intermediate database table. The condition executer 370 may then asynchronously process the SQL statements from the intermediate database table.

In an embodiment, the condition repository 330 may include an attribute to indicate the time of entry of a condition via condition editor 320. In an embodiment, if a conflict is detected between two entered conditions in the condition repository 330, the respective timestamps of the two conditions may be utilized to resolve the conflict. For example, a condition may be entered via condition editor 320 along with a first associated priority. The same condition may be entered again via condition editor 320 along with a second (different) associated priority. To resolve the conflict between the two priorities, for example, the priority associated with the latest timestamp may be assigned to the condition. The conflict may be resolved at any component discussed above (e.g., by the condition repository, the condition interpreter 350, the condition executer 370, and/or the prioritizer).

In another example, a first condition may be entered via condition editor 320 along with a first associated priority. The second (different) condition may be entered again via condition editor 320 along with a second (different) associated priority. However, the SQL statements corresponding to the first condition and the second condition may return one or more of the same database results. Therefore, there may be a conflict as to which priority should be assigned to the database records in common. To resolve the conflict, for example, the priority associated with the latest timestamped condition may be assigned to the records in common.

In an embodiment, the condition repository 330 may include an attribute to indicate the number times a particular condition has been entered via condition editor 320. For example, two users may have entered the same exact condition via condition editor 320. Therefore, in addition to storing the rule, the condition repository 330 may store a frequency indicator indicating that the particular rule's frequency of entry is two. In an embodiment, the condition interpreter 350 and/or the condition executer 370 may only process conditions which exceed a predefined frequency.

The above exemplary embodiments discussed above have been explained in the context of three priorities: “hot,” “cold,” and “warm.” These exemplary priorities are illustrative and not meant to restrict the scope of the invention. In other embodiments, the principles described above may be utilized to prioritize data from an in-memory database into any number of priorities. Similarly, the actions taken on the prioritized data may vary in other embodiments based on the context. For example, in an embodiment, data may be prioritized into five priorities. Data associated with a first priority may be moved to hard disk. Data associated with a second priority may be moved to an in-memory portion of a database. Data associated with a third priority may be moved to a level three cache which provides faster access to the data than the in-memory portion of the database. Data associated with a fourth priority may be moved to a level two cache which provides faster access to the data than the level three cache. Data associated with a fifth priority may be moved to a level one cache which provides faster access to the data than the level two cache.

In an embodiment, the access tracker 110 and the business separator 310 may operate simultaneously to prioritize the data in an in-memory database.

Although database 140/340 is shown as a single database for illustration purposes, in certain embodiments, database 140/340 may be a collection of databases where a substantial portion or all of the data in the collection of databases may be stored in memory.

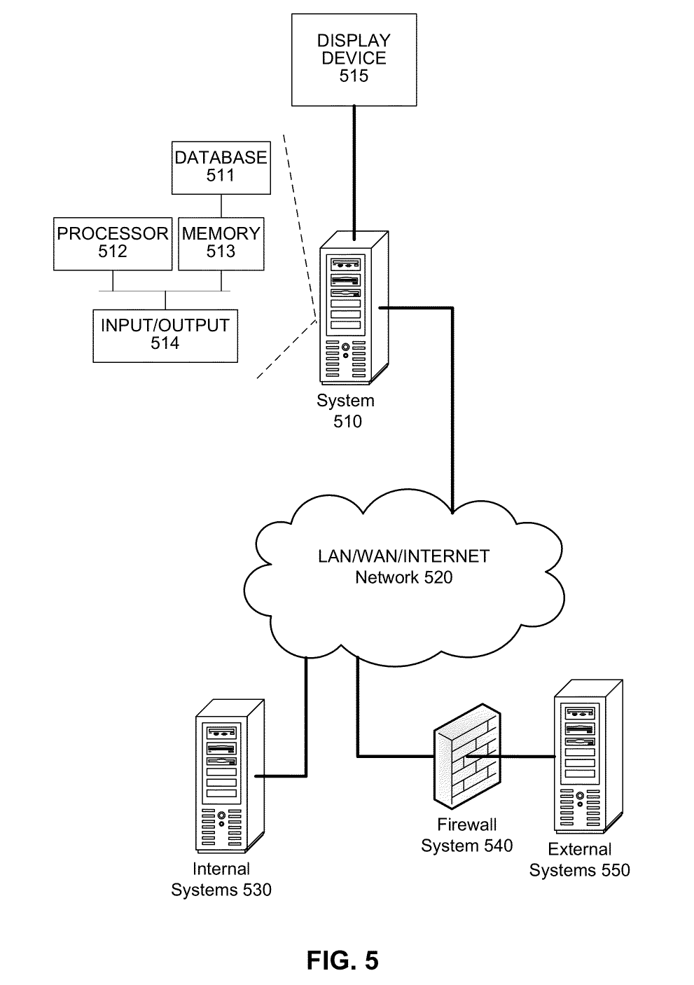

FIG. 5 shows an exemplary architecture in an embodiment of the invention. The system 510 with components to prioritize data as explained above may be coupled to a display device 515, existing internal systems 530 through a network 520 and to external systems 550 through the network 520 and firewall system 540. The system 510 may include a desktop computer, laptop computer, tablet PC, client computer, mobile phone, central computer in a vehicle, any device with a touch screen, and any other computer. The display device 515 may include a computer monitor, a touch screen, a tablet PC screen, a mobile phone screen, and any other displays. The existing internal systems 530 may include a server and may provide business data and/or other data. The external systems 550 may include a server and may be maintained by a third party, such as an information service provider, and may contain business data and/or other data, that may be updated by the third party on a periodic basis. The system 510 may interact with these external systems to obtain updates through a firewall system 540 separating the internal systems from the external systems.

While internal systems 530 and external systems 550 are included in FIG. 5, in some embodiments, one or both of these systems may not be required. In an embodiment, the functionality provided by the internal systems 530 and external systems 550 may be provided by the system 510.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may include different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems. The database 511 may include SAP's HANA (high performance analytic appliance) in-memory computing engine and other such in-memory databases.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
determining, by a computer processor, column accesses to columns of at least one database table based on database queries accessing the at least one database table;
determining row accesses to rows of the at least one database table based on the queries;
assigning a priority to a column of a row from the at least one database table based on the determined column accesses of the column and the row accesses of the row; and
moving the column of the row from random access memory to hard disk based on the assigned priority.

2. The method of claim 1, wherein the at least one database table is entirely stored in random access memory until the moving of the column to the hard disk.

3. The method of claim 1, wherein the priority is assigned based on a frequency of the determined column accesses of the column and the row accesses of the row.

4. A computer-implemented method comprising:
receiving a text condition entered by a user via a graphical user interface;
converting, by a computer processor, the text condition into a database query;
executing the database query to obtain results of the executed query;
identifying database records in at least one database table corresponding to the obtained results;
assigning a predetermined priority to the identified database records; and
moving the database records from random access memory to hard disk based on the assigned priority.

5. The method of claim 4, wherein the predetermined priority is received from the user via the graphical user interface along with the text condition.

6. The method of claim 4, wherein a conflict between the text condition and another text condition is resolved by comparing a timestamp of the text condition and a timestamp of the another text condition.

7. An apparatus comprising:
a processor to:
determine column accesses to columns of at least one database table based on database queries accessing the at least one database table;
determine row accesses to rows of the at least one database table based on the queries;
assign a priority to a column of a row from the at least one database table based on the determined column accesses of the column and the row accesses of the row; and
move the column of the row from random access memory to hard disk based on the assigned priority.

8. The apparatus of claim 7, wherein the at least one database table is entirely stored in random access memory until the moving of the column to the hard disk.

9. The apparatus of claim 7, wherein the priority is assigned based on a frequency of the determined column accesses of the column and the row accesses of the row.

10. An apparatus comprising:
a processor to:
receive a text condition entered by a user via a graphical user interface;
convert the text condition into a database query;
execute the database query to obtain results of the executed query;
identify database records in at least one database table corresponding to the obtained results;
assign a predetermined priority to the identified database records; and
move the database records from random access memory to hard disk based on the assigned priority.

11. The apparatus of claim 10, wherein the predetermined priority is received from the user via the graphical user interface along with the text condition.

12. The apparatus of claim 10, wherein a conflict between the text condition and another text condition is resolved by comparing a timestamp of the text condition and a timestamp of the another text condition.

13. A non-transitory computer-readable medium embodied with computer-executable instructions for causing a computer to execute instructions, the computer instructions comprising:
determining, by a computer processor, column accesses to columns of at least one database table based on database queries accessing the at least one database table;
determining row accesses to rows of the at least one database table based on the queries;
assigning a priority to a column of a row from the at least one database table based on the determined column accesses of the column and the row accesses of the row; and
moving the column of the row from random access memory to hard disk based on the assigned priority.

14. The computer-readable medium of claim 13, wherein the at least one database table is entirely stored in random access memory until the moving of the column to the hard disk.

15. The computer-readable medium of claim 13, wherein the priority is assigned based on a frequency of the determined column accesses of the column and the row accesses of the row.

16. A non-transitory computer-readable medium embodied with computer-executable instructions for causing a computer to execute instructions, the computer instructions comprising:
receiving a text condition entered by a user via a graphical user interface;
converting, by a computer processor, the text condition into a database query;
executing the database query to obtain results of the executed query;
identifying database records in at least one database table corresponding to the obtained results;
assigning a predetermined priority to the identified database records; and
moving the database records from random access memory to hard disk based on the assigned priority.

17. The computer-readable medium of claim 16, wherein the predetermined priority is received from the user via the graphical user interface along with the text condition.

18. The computer-readable medium of claim 16, wherein a conflict between the text condition and another text condition is resolved by comparing a timestamp of the text condition and a timestamp of the another text condition.

19. A computer-implemented method comprising:
determining, by a computer processor, column accesses to columns of at least one database table based on database queries accessing the at least one database table, wherein the column accesses are determined from text of the database queries;
determining row accesses to rows of the at least one database table based on the queries, wherein the row accesses are determined from execution of the queries;
assigning a priority to a column of a row from the at least one database table based on a frequency of the determined column accesses of the column and a frequency of the row accesses of the row; and
moving the column of the row from random access memory to hard disk based on the assigned priority, wherein the at least one database table is entirely stored in random access memory until the moving of the column to the hard disk.
